(19) United States
(12) Patent Application Publication
(10) Pub. No.: US 2026/0228713 A1
(43) Pub. Date: Aug. 6, 2026

(54) FINANCIAL TRANSACTION TERMINAL

(71) Applicant: PAX COMPUTER TECHNOLOGY (SHENZHEN) CO.,LTD., Shenzhen (CN)

(72) Inventors: Changxiang ZHENG, Shenzhen (CN); Yuan CHENG, Shenzhen (CN); Lishan WAN, Shenzhen (CN); Minghui HUANG, Shenzhen (CN); Deqiang DONG, Shenzhen (CN); Xiaoli LIU, Shenzhen (CN); Jingyang LI, Shenzhen (CN)

(21) Appl. No.: 19/103,606

(22) PCT Filed: Jul. 27, 2023
(86) PCT No.: PCT/CN2023/109675

§ 371 Date: Feb. 13, 2025

(30) Foreign Application Priority Data
Aug. 16, 2022 (CN) 202222156266.8

(51) Int. Cl. G06Q 20/20

(52) U.S. Cl. CPC G06Q 20/209; G06Q 20/204

(57) ABSTRACT

The present application provides a financial transaction terminal, including a housing, a metal plate and a circuit board. The circuit board has a grounding wire, and an NFC signal source is electrically connected to the circuit board. A first connection point and a second connection point are arranged at intervals on the metal plate, and the first connection point is connected to the grounding wire of the circuit board by a first conductive member, and the grounding terminal of the NFC signal source is connected to the grounding wire, and the second connection point is connected to the positive terminal of the NFC signal source by a second conductive member. The financial transaction terminal provided by the present application utilizes the metal plate in the housing so that a hollow area is formed between the metal plate, the first conductive member, the second conductive member and the grounding wire of the circuit board. Due to the edge effect of the current, the hollow area constitutes an NFC antenna, and thus there is no need to separately set up an NFC panel area and the NFC antenna, which is lower in cost. Due to the utilization of the metal plate in the housing, the integration is higher and the space occupied is smaller.

This application claims priority to Chinese Patent Application No. 202222156266.8 filed on Aug. 16, 2022, in China National Intellectual Property Administration, the contents of which are incorporated by reference herein.

### FIELD

The present application belongs to a field of financial transaction technology, and more specifically, to a financial transaction terminal.

### BACKGROUND

NFC (Near Field Communication) is a short-range wireless communication technology. Its advantages of speed, security and convenience are widely recognized and widely used in financial transaction terminals such as POS (point of sale) machines and cash registers. With the development of technology, the integration of electronic products is getting higher and higher, the size of electronic products is getting smaller and smaller, and the cost control of electronic products is also getting higher and higher. At present, a NFC panel area is generally set in a housing, and a NFC antenna is set on the NFC panel area. However, the above structure requires a special NFC panel area, which occupies a large area and is costly.

### DESCRIPTION OF THE DRAWINGS

In order to more clearly illustrate the technical solutions in the embodiments of the present application, the drawings required for use in the embodiments or exemplary technical descriptions will be briefly introduced below. Obviously, the drawings described below are only some embodiments of the present application. For ordinary technicians in this field, other drawings can be obtained based on these drawings without paying creative work.

FIG. 1 is a structural schematic diagram of a financial transaction terminal provided in embodiment one of the present application;

FIG. 2 is a schematic diagram of an internal structure of the financial transaction terminal of FIG. 1;

FIG. 3 is an enlarged structural schematic diagram of part A in FIG. 2;

FIG. 4 is a schematic diagram of the internal structure of the financial transaction terminal provided in embodiment two of the present application;

FIG. 5 is an enlarged structural schematic diagram of t part B in FIG. 4;

FIG. 6 is a structure schematic diagram of the financial transaction terminal provided in embodiment three of the present application;

FIG. 7 is a schematic diagram of the internal structure of the financial transaction terminal of FIG. 6;

FIG. 8 is an enlarged structural schematic diagram of part C in FIG. 7;

FIG. 9 is a schematic diagram of the internal structure of the financial transaction terminal provided in embodiment four of the present application;

FIG. 10 is an enlarged structural schematic diagram of portion D in FIG. 9;

FIG. 11 is a structural schematic diagram of a circuit board of the financial transaction terminal provided in embodiment five of the present application.

Among them, main marks of the drawings in the figures are:

1 00-Financial transaction terminal;

11-housing; 111-paper outlet; 12-circuit board; 121-grounding wire; 122-grounding point; 123-metal trace; 13-NFC signal source; 131-grounding terminal; 132-positive terminal; 141-first conductive member; 142-second conductive member; 15-metal plate; 151-first connection point; 152-second connection point; 16-printer; 161-printer cover; 162-paper cutter blade; 17-display screen; 171-back panel; 18-conductive wire.

### DETAILED DESCRIPTION OF THE INVENTION

In order to make the technical problems, technical solutions and beneficial effects to be solved by the present application more clearly understood, the present application is further described in detail below in conjunction with the accompanying drawings and embodiments. It should be understood that the specific embodiments described herein are only used to explain the present application and are not used to limit the present application.

It should be noted that when an element is referred to as being “fixed to” or “disposed on” another element, it can be directly on the other element or indirectly on the other element. When an element is referred to as being “connected to” another element, it can be directly connected to the other element or indirectly connected to the other element.

In addition, terms “first” and “second” are used for descriptive purposes only and should not be understood as indicating or implying relative importance or implicitly indicating the number of technical features indicated. Therefore, a feature defined as “first” or “second” may explicitly or implicitly include one or more of the features. In the description of the present application, “multiple” means two or more, unless otherwise clearly and specifically defined. “Several” means one or more, unless otherwise clearly and specifically defined.

In the description of the present application, it should be understood that the terms “center”, “length”, “width”, “thickness”, “up”, “down”, “front”, “back”, “left”, “right”, “vertical”, “horizontal”, “top”, “bottom”, “inside”, “outside”, etc., indicating an orientation or position relationship are based on the orientation or position relationship shown in the drawings, and are only for the convenience of describing the present application and simplifying the description, and do not indicate or imply that the device or element referred to must have a specific orientation, be constructed and operated in a specific orientation, and therefore should not be understood as a limitation on the present application.

In the description of this application, it should be noted that, unless otherwise clearly specified and limited, the terms “installed”, “connected”, and “connected” should be understood in a broad sense, for example, it can be a fixed connection, a detachable connection, or an integral connection; it can be a mechanical connection or an electrical connection; it can be a direct connection or an indirect connection by an intermediate medium; it can be the internal connection of two elements or the interaction relationship between two elements. For ordinary technicians in this field, the specific meanings of the above terms in the present application can be understood according to specific circumstances.

References to “one embodiment”, “some embodiments” or “an embodiment” described in the specification of this application mean that a particular feature, structure or characteristic described in conjunction with the embodiment is included in one or more embodiments of the present application. Thus, the phrases “in one embodiment”, “in some other embodiments”, “in some other embodiments”, etc., which appear at different places in the specification, do not necessarily refer to the same embodiment, but mean “one or more but not all embodiments”, unless otherwise specifically emphasized in other ways. In addition, in one or more embodiments, particular features, structures or characteristics may be combined in any suitable manner.

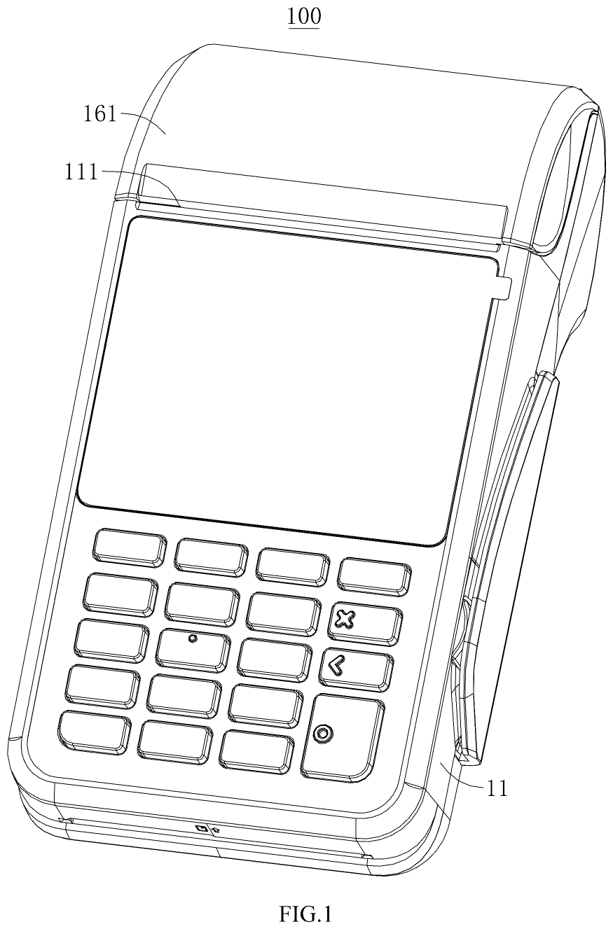

Please refer to FIGS. 1 to 3, and the financial transaction terminal 100 provided in the embodiment of the present application is described. The financial transaction terminal 100 includes a housing 11, a metal plate 15 and a circuit board 12. The metal plate 15 and the circuit board 12 are both installed in the housing 11. The circuit board 12 includes a grounding wire 121, and the circuit board 12 is electrically connected to a NFC signal source 13, and the NFC signal source 13 is mainly used for generating and receiving NFC signals. The metal plate 15 is provided with a first connection point 151 and a second connection point 152 at intervals, and the first connection point 151 is connected to the grounding wire 121 of the circuit board 12 by a first conductive member 141. The grounding terminal 131 of the NFC signal source 13 is connected to the grounding wire 121, and the second connection point 152 is connected to the positive terminal 132 of the NFC signal source 13 by a second conductive member 142. In this way, the metal plate 15, the first conductive member 141, the second conductive member 142, the grounding wire 121 of the circuit board 12 and the NFC signal source 13 form a conductive loop, and a hollow area is formed by the metal plate 15, the first conductive member 141, the second conductive member 142 and the grounding wire 121 of the circuit board 12. An inner side of the hollow area forms a loop with the NFC signal source 13. When the current passes through the hollow area, due to an edge effect of the current (also known as the skin effect, the skin effect, the surface effect, the surface effect), the NFC signal current flows along the inner side of the hollow area to form a closed loop, so that coils are formed in the hollow area, when the NFC signal source 13 generates an electrical signal, the current generates an electromagnetic signal in the hollow area; when the electromagnetic signal passes through the hollow area, an induced current is generated, and the induced current is received by the NFC signal source 13, thereby realizing the transmission and reception of the NFC signal, so that the hollow area constitutes an NFC antenna. In this way, the metal plate 15 in the housing 11 is used to form the NFC antenna with the grounding wire 121 of the circuit board 12, so there is no need to separately set up an NFC panel area and an NFC antenna, which reduces costs, increases integration, and occupies less space.

Compared with the prior art, the financial transaction terminal 100 provided in the embodiment of the present application uses the metal plate 15 in the housing 11, and sets the first connection point 151 and the second connection point 152 on the metal plate 15 at intervals, and connects the first connection point 151 to the grounding wire 121 on the circuit board 12, and connects the second connection point 152 to the positive terminal 132 of the NFC signal source 13, and connects the grounding wire 121 to the grounding terminal 131 of the NFC signal source 13, so that the hollow area is formed between the metal plate 15, the first conductive member 141, the second conductive member 142 and the grounding wire 121 of the circuit board 12. Due to the edge effect of the current, when the grounding terminal 131 of the NFC signal source 13 and the positive terminal 132 pass through electricity, the hollow area forms coils to generate the electromagnetic signal; and when the electromagnetic signal passes through the hollow area, the induced current is generated and received by the NFC signal source 13, so that the hollow area constitutes the NFC antenna, and there is no need to separately set up the NFC panel area and the NFC antenna, so the cost is lower. Since the metal plate 15 in the housing 11 is used, the integration is higher and the space occupied is smaller.

In one embodiment, the NFC signal source 13 may be directly mounted on the circuit board 12. In another embodiment, the NFC signal source 13 may also be connected to the circuit board 12 by a wire.

In one embodiment, referring to FIG. 1 to FIG. 3, the printer 16 is installed in the housing 11, and the metal plate 15 is a paper cutting blade 162 of the printer 16, that is, the paper cutting blade 162 of the printer 16 is used to form the NFC antenna to reduce costs.

In one embodiment, the first conductive member 141 is a wire, which is convenient for connection. It can be understood that the first conductive member 141 can also be a conductive structure such as a metal strip. In another embodiment, when other devices are provided between the paper cutting blade 162 and the circuit board 12, the first conductive member 141 can be a grounding trace of the device.

In one embodiment, the second conductive member 142 is a wire, which is convenient for connection. It can be understood that the second conductive member 142 can also be a conductive structure such as a metal strip.

In one embodiment, a grounding point 122 is provided on the circuit board 12, and the grounding point 122 is located adjacent to the first connection point 151, and the grounding point 122 is connected to the grounding wire 121, and the first conductive member 141 is connected to the grounding point 122. The grounding point 122 is provided to facilitate the connection between the first conductive member 141 and the grounding wire 121. It can be understood that the first conductive member 141 can also be connected to a grounding pad on the circuit board 12.

In one embodiment, a first contact point may be separately provided on the circuit board 12, and the first contact point is connected to the grounding wire 121, and the first contact point is connected to a ground of the NFC signal source 13 by a trace or a wire, and the first contact point serves as the grounding terminal 131 of the NFC signal source 13. In another embodiment, the connection point between the grounding wire 121 and the NFC signal source 13 may also be directly used as the grounding terminal 131 of the NFC signal source 13.

In one embodiment, a second contact point may be separately provided on the circuit board 12, and the second conductive member 142 is connected to the second contact point, and the second contact point is connected to a positive electrode of the NFC signal source 13 by a trace or a wire, and the second contact point serves as the positive terminal 132 of the NFC signal source 13. In another embodiment, the connection point between the second conductive member 142 and the NFC signal source 13 may also be directly connected as the positive terminal 132 of the NFC signal source 13.

In one embodiment, a distance between the grounding point 122 and the positive terminal 132 of the NFC signal source 13 is in a range of 30-120 mm to ensure performance of the NFC antenna. If the distance between the grounding point 122 and the positive terminal 132 of the NFC signal source 13 is too close (for example, less than 30 mm), the NFC performance will be significantly reduced; if the distance between the grounding point 122 and the positive terminal 132 of the NFC signal source 13 is too far (for example, greater than 120 mm), the NFC performance will also be reduced.

In one embodiment, a distance between the circuit board 12 and a side of the paper cutting blade 162 adjacent to the first connection point 151 is greater than or equal to 0.5 mm to ensure that the hollow area enclosed by the paper cutting blade 162, the first conductive member 141, the second conductive member 142 and the grounding wire 121 of the circuit board 12 has a certain area to form a loop.

In one embodiment, the first connection point 151 and the second connection point 152 are located adjacent to one side of the paper cutter blade 162 and adjacent to one side of the circuit board 12 on the paper cutter blade 162 to reduce the NFC signal loop impedance, and improve NFC performance, and also reduce interference with other circuits on the circuit board 12.

In one embodiment, the financial transaction terminal 100 further includes a magnetic conductive layer (not shown), which at least covers the hollow area enclosed by the paper cutting blade 162, the first conductive member 141, the second conductive member 142 and the grounding wire 121 of the circuit board 12 to improve the NFC performance. The magnetic conductive layer can be made of materials such as ferrite.

In one embodiment, a distance between the first connection point 151 and the second connection point 152 is in a range of 30-120 mm to ensure the performance of the NFC antenna. If the distance between the first connection point 151 and the second connection point 152 is too close (for example, less than 30 mm), the NFC performance will be significantly reduced; if the distance between the first connection point 151 and the second connection point 152 is too far (for example, greater than 120 mm), the NFC performance will also be reduced.

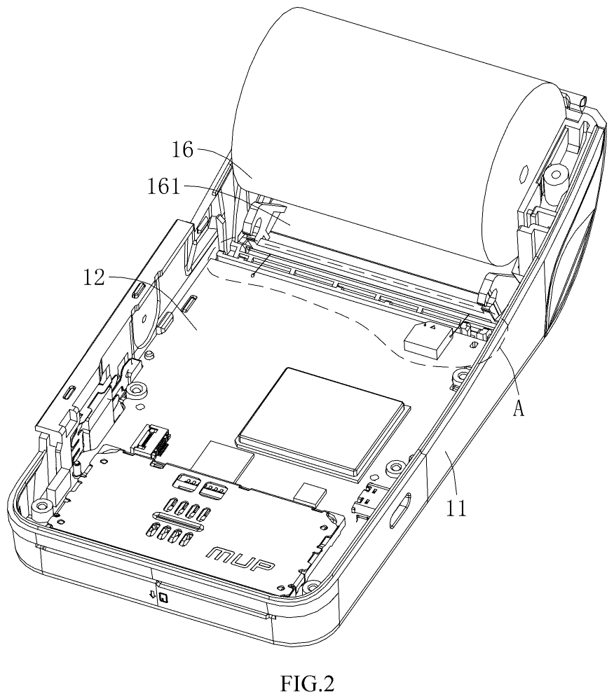

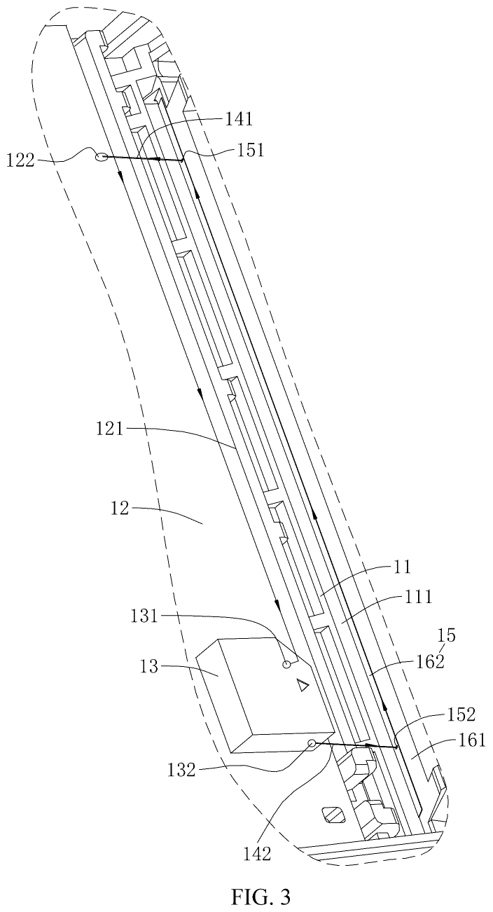

In one embodiment, referring to FIG. 2 and FIG. 3, a printer cover 161 is disposed on the housing 11, and a paper outlet 111 is formed between the printer cover 161 and the housing 11, and the paper cutting blade 162 may be disposed on the printer cover 161.

In the above embodiment, since the printer cover 161 is rotatably mounted on the housing 11, the first conductive member 141 can use a metal spring to contact and connect with the grounding wire 121 on the circuit board 12. The second conductive member 142 can also use a metal spring to contact and connect with the positive terminal 132 of the NFC signal source 13 on the circuit board 12, thereby facilitating the opening of the printer cover 161.

It is understandable that the first conductive member 141 may use a metal spring to contact and connect with the paper cutting blade 162, and the second conductive member 142 may use a metal spring to contact and connect with the paper cutting blade 162, thereby facilitating opening of the printer cover 161.

Please refer to FIG. 2 and FIG. 3. In one embodiment, a closed loop is formed between the paper cutting blade 162, the first conductive member 141, the second conductive member 142, the grounding wire 121 of the circuit board 12 and the NFC signal source 13. When current passes through the closed loop, such as the electromagnetic field passing through the closed loop to form an induced current, or the NFC signal source 13 actively loads current, the current follows the arrow in FIG. 3, from the positive terminal 132 of the NFC signal source 13, through the second conductive member 142, the edge of the paper cutting blade 162, the first conductive member 141, the grounding wire 121 of the circuit board 12 to the grounding terminal 131 of the NFC signal source 13, so as to form the closed loop, realize the transmission and reception of NFC signals, make full use of the paper cutting blade 162 of the printer 16, improve integration and reduce costs.

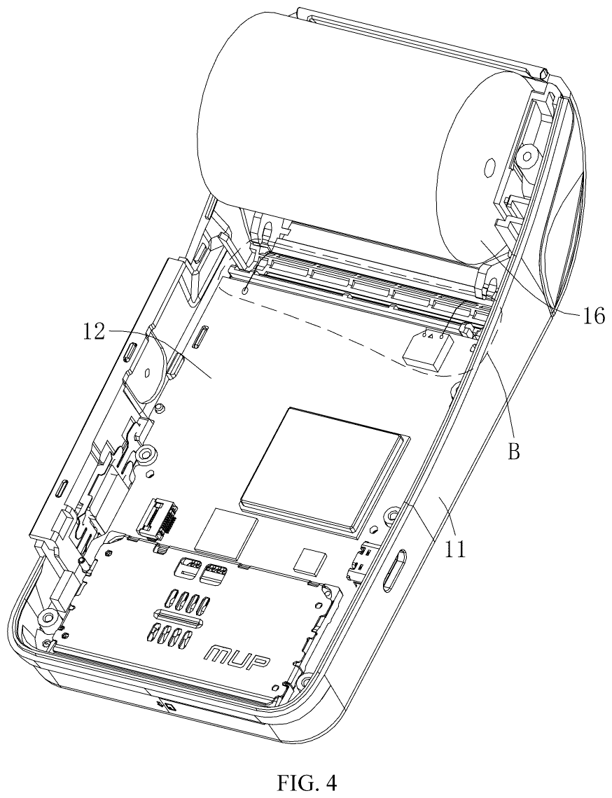

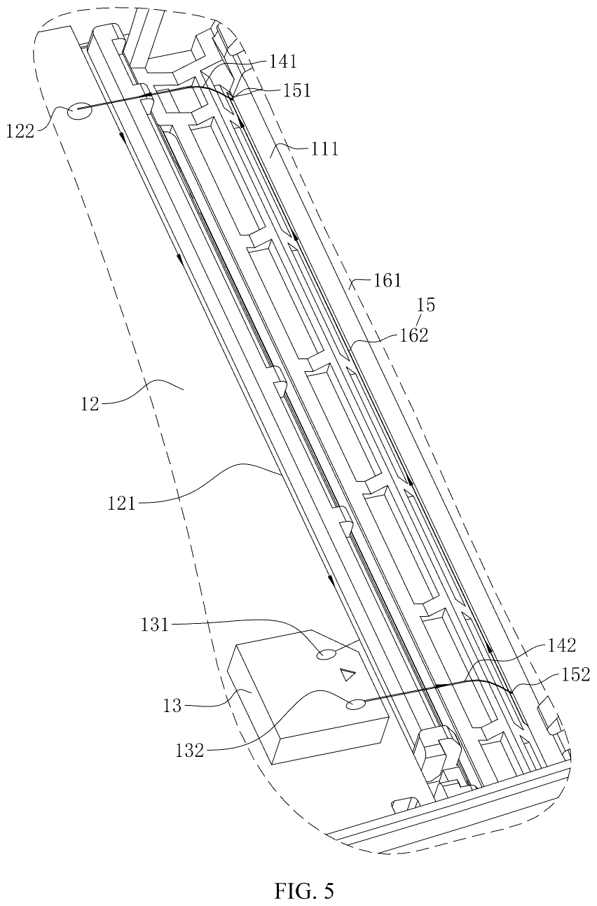

Please refer to FIG. 4 and FIG. 5, the structure of the financial transaction terminal of the embodiment is different from the structure of the financial transaction terminal of the embodiments shown in FIG. 2 and FIG. 3 as follows: in the embodiment, the printer cover 161 is provided on the housing 11, a paper outlet 111 is formed between the printer cover 161 and the housing 11, and the paper cutting blade 162 can be provided on the housing 11.

In one embodiment, the first conductive member 141 can use a wire to connect the paper cutting blade 162 to the grounding wire 121 on the circuit board 12, and the connection is firm and stable. The second conductive member 142 can use a wire to connect the paper cutting blade 162 to the positive terminal 132 of the NFC signal source 13, and the connection is firm and stable.

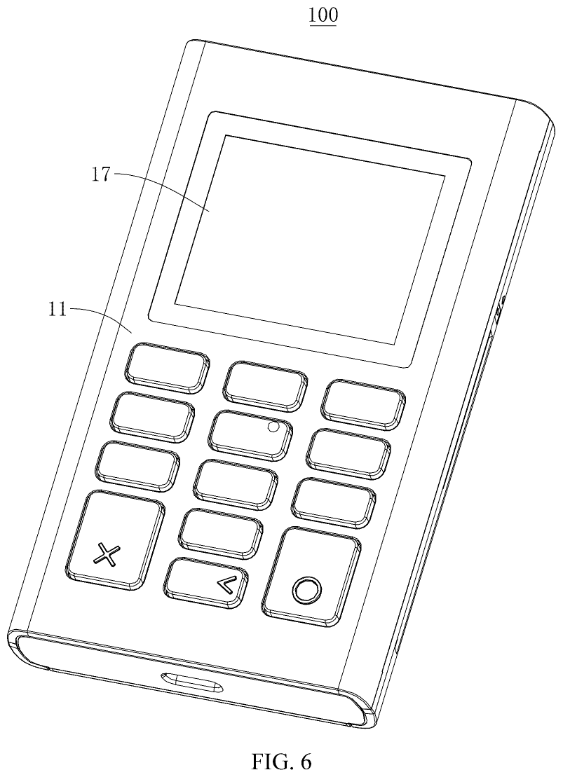

Please refer to FIG. 6 to FIG. 8, the difference between the structure of the financial transaction terminal of the embodiment and the structure of the financial transaction terminal of the embodiments shown in FIG. 2 and FIG. 3 is that in this embodiment, a display screen 17 is installed on the housing 11. Since the back panel 171 of the display screen 17 is made of metal, the metal plate 15 can be a back panel 171 of the display screen 17. In other words, the back panel 171 of the display screen 17 is used to form the NFC antenna to reduce costs.

In one embodiment, a distance between the circuit board 12 and the back plate 171 on the side adjacent to the first connection point 151 is greater than or equal to 0.5 mm to ensure that the hollow area enclosed by the back plate 171, the first conductive member 141, the second conductive member 142 and the grounding wire 121 of the circuit board 12 has a certain area to form a loop.

In one embodiment, the first connection point 151 and the second connection point 152 are located adjacent to a side edge of the back plate 171. For example, the first connection point 151 and the second connection point 152 can be located on the back plate 171 adjacent to the side of the NFC signal source 13 to reduce the NFC signal loop impedance, and improve NFC performance, and also reduce interference with other circuits on the circuit board 12.

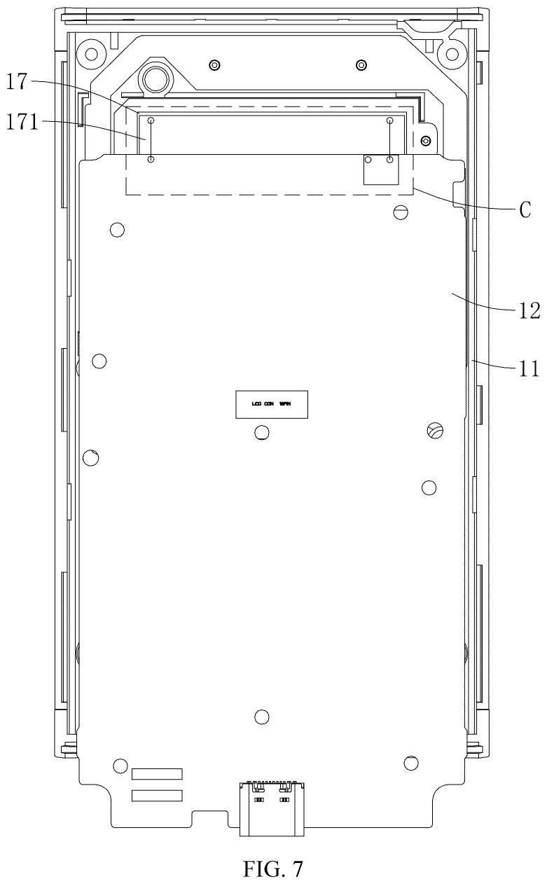

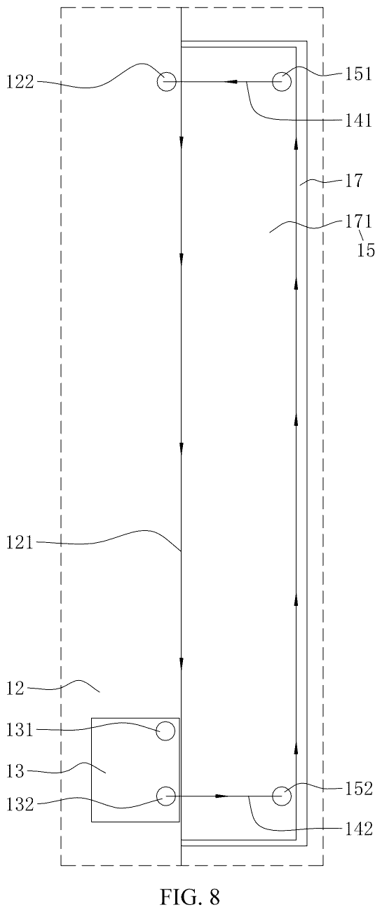

Please refer to FIG. 7 and FIG. 8. In the embodiment, a closed loop is formed between the back plate 171, the first conductive member 141, the second conductive member 142, the grounding wire 121 of the circuit board 12 and the NFC signal source 13. When current passes through the closed loop, such as the electromagnetic field passing through the closed loop to form the induced current, or the NFC signal source 13 actively loads current, the current follows the arrow in FIG. 8, from the positive terminal 132 of the NFC signal source 13, through the second conductive member 142, the edge of the back plate 171, the first conductive member 141, the grounding wire 121 of the circuit board 12 to the grounding terminal 131 of the NFC signal source 13, so as to form the closed loop, and realize the transmission and reception of NFC signals, make full use of the back plate 171 of the display screen 17, and improve the integration and reduce the cost.

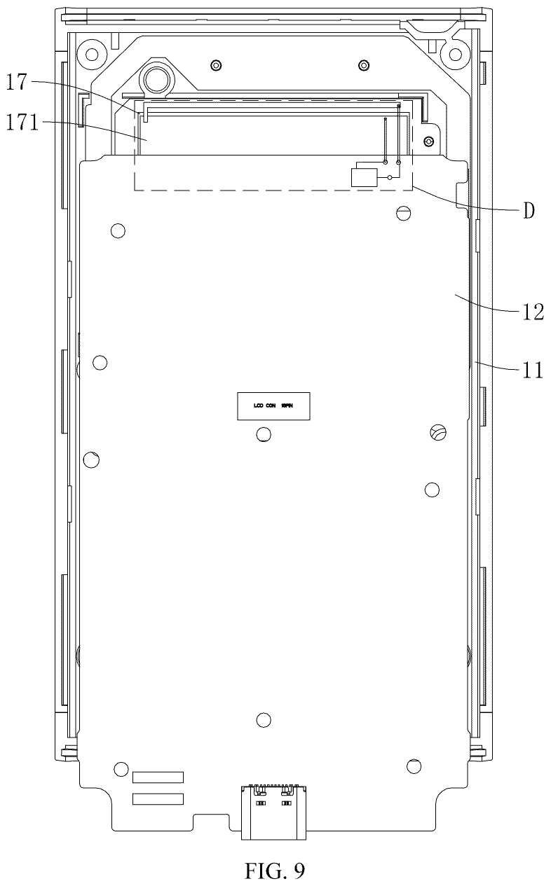

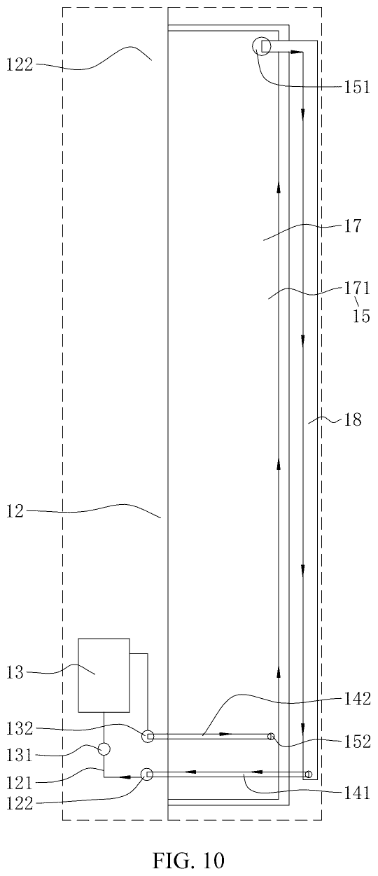

Referring to FIGS. 9 and 10, the structure of the financial transaction terminal of the present embodiment is different from that of the financial transaction terminal of the embodiment shown in FIGS. 7 and 8 is that: in the present embodiment, a display screen 17 and a conductive wire 18 are mounted on the housing 11. Since the back plate 171 of the display screen 17 is made of metal, the metal plate 15 can be the back plate 171 of the display screen 17. The conductive wire 18 is extended along one side of the back plate 171 adjacent to the first connection point 151 and the second connection point 152. The distance between conductive wire 18 and the side adjacent to the first connection point 151 on the back plate 171 is greater than or equal to 0.5 mm, one end of the conductive wire 18 is electrically connected to the first connection point 151, and the other end of the conductive wire 18 is connected to the first conductive member 141, so that the closed loop is formed between the back plate 171, the conductive wire 18, the first conductive member 141, the second conductive member 142, the grounding wire 121 of the circuit board 12 and the NFC signal source 13, and a space between the conductive wire 18 and the back plate 171 can better determine a hollow shape of the loop, thereby improving the NFC performance.

In one embodiment, the conductive wire 18 may be connected to the first connection point 151 of the back plate 171 by a conductive wire. In another embodiment, one end of the conductive wire 18 may also be bent and connected to the first connection point 151.

Please refer to FIGS. 9 and 10. In the embodiment, a closed loop is formed between the back plate 171, the conductive wire 18, the first conductive member 141, the second conductive member 142, the grounding wire 121 of the circuit board 12 and the NFC signal source 13. When current passes through the closed loop, such as the electromagnetic field passing through the closed loop to form an induced current, or the NFC signal source 13 actively loads current, the current follows the arrow in FIG. 10, from the positive terminal 132 of the NFC signal source 13, through the second conductive member 142, the edge of the back plate 171, the conductive wire 18, the first conductive member 141, the grounding wire 121 of the circuit board 12 to the grounding terminal 131 of the NFC signal source 13, so as to form a closed loop, realize the transmission and reception of NFC signals, make full use of the back plate 171 of the display screen 17, improve the integration and reduce the cost.

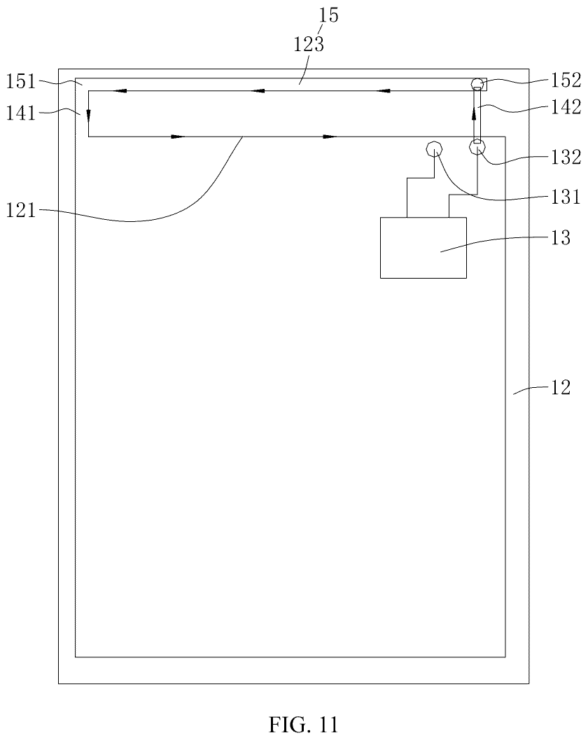

Please refer to FIG. 11, the difference between the structure of the financial transaction terminal of the embodiment and the structure of the financial transaction terminal of the embodiments shown in FIG. 7 and FIG. 8 is as follows: in the embodiment, the metal plate 15 is a metal trace 123 disposed on one side of the circuit board 12, and the two ends of the metal trace 123 respectively form the first connection point 151 and the second connection point 152, and the grounding wire 121 connected to the grounding terminal 131 of the NFC signal source 13 on the circuit board 12 is arranged at intervals from the metal trace 123, and the first conductive member 141 is a circuit trace disposed on one side of the circuit board 12. In other words, the metal trace 123 on the circuit board 12 is used to form the NFC antenna to reduce costs.

Please refer to FIG. 11, in the embodiment, a closed loop is formed between the metal trace 123, the first conductive member 141, the second conductive member 142, the grounding wire 121 of the circuit board 12, and the NFC signal source 13. When current passes through the closed loop, such as an electromagnetic field passing through the closed loop to form an induced current, or the NFC signal source 13 actively loads current, the current flows along the arrow in FIG. 11, from the positive terminal 132 of the NFC signal source 13, through the second conductive member 142, the metal trace 123, the first conductive member 141, the grounding wire 121 of the circuit board 12 to the grounding terminal 131 of the NFC signal source 13, so as to form a closed loop, realize the transmission and reception of NFC signals, make full use of the back panel 171 of the display screen 17, improve the integration, and reduce the cost.

It can be understood that the metal plate 15 can also be other metal components in the housing 11, such as a reinforced metal plate in the housing 11. Both ends of the metal plate can be connected to the circuit board 12 by screws, so that the metal plate, two screws, the grounding wire on the circuit board 12, and the NFC signal source 13 form a transmitting and receiving circuit for the NFC signal.

The financial transaction terminal 100 of the embodiment of the present application can use the metal plate 15 of the existing internal components to manufacture the NFC antenna, which occupies a small space, and has high integration and low cost.

The above description is only an optional embodiment of the present application and is not intended to limit the present application. Any modifications, equivalent substitutions and improvements made within the spirit and principles of the present application should be included in the protection scope of the present application.

1. A financial transaction terminal, comprising a housing, a metal plate installed in the housing, and a circuit board installed in the housing, the circuit board comprising a grounding wire, and the circuit board being electrically connected to an NFC signal source, wherein a first connection point and a second connection point are arranged on the metal plate at intervals, and the first connection point is connected to the grounding wire of the circuit board by a first conductive member, and a grounding terminal of the NFC signal source is connected to the grounding wire, and the second connection point is connected to a positive terminal of the NFC signal source by a second conductive member.

2. The financial transaction terminal according to claim 1, wherein the housing is equipped with a printer, and the metal plate is a paper cutting blade of the printer.

3. The financial transaction terminal according to claim 1, wherein the housing is equipped with a display screen, and the metal plate is a back plate of the display screen.

4. The financial transaction terminal according to claim 1, wherein the metal plate is a metal trace disposed on one side of the circuit board, and two ends of the metal trace respectively form the first connection point and the second connection point, and the first conductive member is a circuit trace disposed on one side of the circuit board, and the grounding wire adjacent to the grounding terminal of the NFC signal source is spaced apart from the metal trace.

5. The financial transaction terminal according to claim 1, wherein a grounding point is provided on the circuit board adjacent to the first connection point, and the grounding point is connected to the grounding wire, and the first conductive member is connected to the grounding point, and a distance between the grounding point and the positive terminal of the NFC signal source is in a range of 30-120 mm.

6. The financial transaction terminal according to claim 5, wherein a distance between the circuit board and a side of the metal plate adjacent to the first connection point is greater than or equal to 0.5 mm.

7. The financial transaction terminal according to claim 1, wherein the financial transaction terminal further comprises a magnetic conductive layer, and the magnetic conductive layer covers at least a hollow area enclosed by the metal plate, the first conductive member, the second conductive member and the grounding wire of the circuit board.

8. The financial transaction terminal according to claim 1, wherein the housing is equipped with a conductive wire, and the conductive wire is extended along a side of the metal plate adjacent to the first connection point and the second connection point, and a distance between the conductive wire and the side of the metal plate adjacent to the first connection point is greater than or equal to 0.5 mm, and one end of the conductive wire is electrically connected to the first connection point, and the other end of the conductive wire is connected to the first conductive member.

9. The financial transaction terminal according to claim 1, wherein the distance between the first connection point and the second connection point ranges from 30 to 120 mm.

10. The financial transaction terminal according to claim 1, wherein the first connection point and the second connection point are both arranged on a side edge of the metal plate adjacent to the circuit board.

11. The financial transaction terminal according to claim 1, wherein the first conductive member can a wire or a metal strip.

12. The financial transaction terminal according to claim 1, wherein the second conductive member can a wire or a metal strip.

13. The financial transaction terminal according to claim 2, wherein a grounding point is provided on the circuit board adjacent to the first connection point, and the grounding point is connected to the grounding wire, and the first conductive member is connected to the grounding point, and a distance between the grounding point and the positive terminal of the NFC signal source is in a range of 30-120 mm.

14. The financial transaction terminal according to claim 3, wherein a grounding point is provided on the circuit board adjacent to the first connection point, and the grounding point is connected to the grounding wire, and the first conductive member is connected to the grounding point, and a distance between the grounding point and the positive terminal of the NFC signal source is in a range of 30-120 mm.

15. The financial transaction terminal according to claim 2, wherein the financial transaction terminal further comprises a magnetic conductive layer, and the magnetic conductive layer covers at least a hollow area enclosed by the metal plate, the first conductive member, the second conductive member and the grounding wire of the circuit board.

16. The financial transaction terminal according to claim 3, wherein the financial transaction terminal further comprises a magnetic conductive layer, and the magnetic conductive layer covers at least a hollow area enclosed by the metal plate, the first conductive member, the second conductive member and the grounding wire of the circuit board.

17. The financial transaction terminal according to claim 4, wherein the financial transaction terminal further comprises a magnetic conductive layer, and the magnetic conductive layer covers at least a hollow area enclosed by the metal plate, the first conductive member, the second conductive member and the grounding wire of the circuit board.

18. The financial transaction terminal according to claim 2, wherein the housing is equipped with a conductive wire, and the conductive wire is extended along a side of the metal plate adjacent to the first connection point and the second connection point, and a distance between the conductive wire and the side of the metal plate adjacent to the first connection point is greater than or equal to 0.5 mm, and one end of the conductive wire is electrically connected to the first connection point, and the other end of the conductive wire is connected to the first conductive member.

19. The financial transaction terminal according to claim 3, wherein the housing is equipped with a conductive wire, and the conductive wire is extended along a side of the metal plate adjacent to the first connection point and the second connection point, and a distance between the conductive wire and the side of the metal plate adjacent to the first connection point is greater than or equal to 0.5 mm, and one end of the conductive wire is electrically connected to the first connection point, and the other end of the conductive wire is connected to the first conductive member.

20. The financial transaction terminal according to claim 2, wherein the first connection point and the second connection point are both arranged on a side edge of the metal plate adjacent to the circuit board.
